(19) United States
(12) Patent Application Publication
(10) Pub. No.: US 2010/0068928 A1
(43) Pub. Date: Mar. 18, 2010

(54) Female adaptor for a connector

(75) Inventors: CHEN-CHIA HUANG, Taipei Hsien (TW); YI-DUN CHEN, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/457,306

(22) Filed: Jun. 8, 2009

(30) Foreign Application Priority Data
Sep. 15, 2008 (TW) 097135397

(51) Int. Cl. H01R 9/18

(52) U.S. Cl. 439/583

(57) ABSTRACT

A female adapter for a connector is disclosed. The female adapter is used to match a male adapter having a male pin. The female adapter comprises an outer ring and an internal component. The outer ring having screw threads and is used to match with the male adapter. The internal component has a hole and a chamber and is used to accommodate the male pin. The internal component further comprises a protruding portion and is able to match the internal structure of the outer ring and extend the length of the chamber.

### BACKGROUND OF THE INVENTION

1. Field of the Invention

The present invention relates to a female adaptor of a connector, more particularly, to a female adaptor of a connector which has an extendable chamber.

2. Description of the Related Art

In the development of modern technology, female and male adapters are often used to interconnect the cables with the electronic devices for the transmission of electronic signals. Nowadays, F-type connectors are used prevalently for the interconnection of various types of applications.

FIG. 1A shows the connection between a male and a female adaptor of the prior art. As shown in FIG. 1A, a female adapter 91 comprises an outer ring 911 and an internal component 912; a male adapter 92 comprises a male pin 921. The female adapter 91 can be screw-fastened to the male adapter 92 by means of the screw thread 911 a of the outer ring 911.

Refer to FIG. 1B and FIG. 1C for a female adaptor of the prior art. FIG. 1B shows the cross-sectional diagram of a female adaptor; FIG. 1C shows the internal component of a female adaptor.

As shown in FIG. 1B and FIG. 1C, the internal component 912 of the female adaptor 91 comprises a hole 912a and a chamber 912b to accommodate the male pin 921 of the male adaptor 92. The internal component 912 is made to comply with the structure of the outer ring 911, as a result, the chamber 912b of the female adaptor 91 is relatively shorter than some male pin 921 of the male adaptor 92 of the prior art, thus the male pin 921 cannot be completely embedded into the chamber 912b of the female adaptor 91. Therefore, the male pin 921 must be pruned in order to fit into the chamber, and it will cause usage inconvenience. On the other hand, if the shape of the outer ring 911 of the female adaptor 91 is modified to accommodate the length of the male pin 921, the manufacturing cost would escalate.

Therefore, a new design for a female adaptor is needed to resolve the problems mentioned in the prior art.

### SUMMARY OF THE INVENTION

The objective of the present invention is to provide a female adaptor for a connector, which would be able to extend the length of the internal chamber of the internal component.

In order to achieve the above mentioned objective, the invention presents a female adapter which is used to match with a male adapter which has a male pin. The female adapter comprises an outer ring and an internal component. The outer ring has a screw thread and is used to match with the male adapter. The internal component is disposed in the outer ring. The internal component has a hole as well as a chamber and is used to accommodate the male pin. The internal component further comprises a protruding portion and is able to match with the internal structure of the outer ring and extend the length of the chamber.

### BRIEF DESCRIPTION OF THE DRAWINGS

FIG. 1A shows the connection between a male and a female adaptor for the prior art.

FIG. 1B shows the cross-sectional diagram of a female adaptor for the prior art.

FIG. 1C shows the internal component of a female adaptor for the prior art.

FIG. 2 shows the cross-sectional diagram of a female adaptor according to an embodiment of the invention.

FIG. 3 shows the internal component of a female adaptor according to an embodiment of the invention.

FIG. 4 shows the internal component of a female adaptor having a rubber cushion according to an embodiment of the invention.

FIG. 5 shows the internal component of a female adaptor having a plastic cushion according to an embodiment of the invention.

### DETAILED DESCRIPTION OF THE PREFERRED EMBODIMENT

The advantages and innovative features of the invention will become more apparent from the following embodiments.

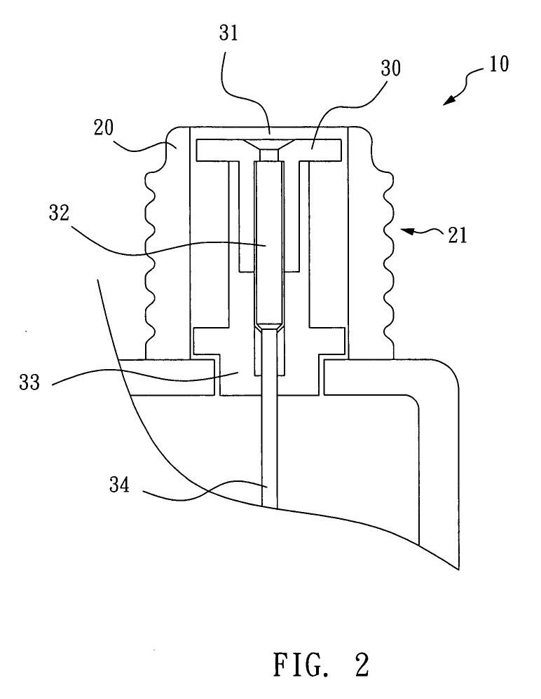

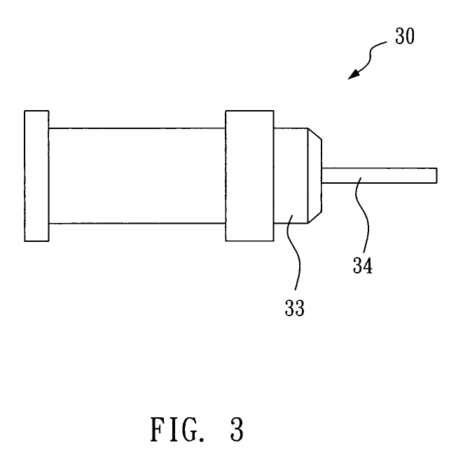

Refer to FIG. 2˜3 for the female adaptor according to an embodiment of the invention. FIG. 2 shows the cross-sectional diagram of a female adaptor; FIG. 3 shows the internal component of a female adaptor.

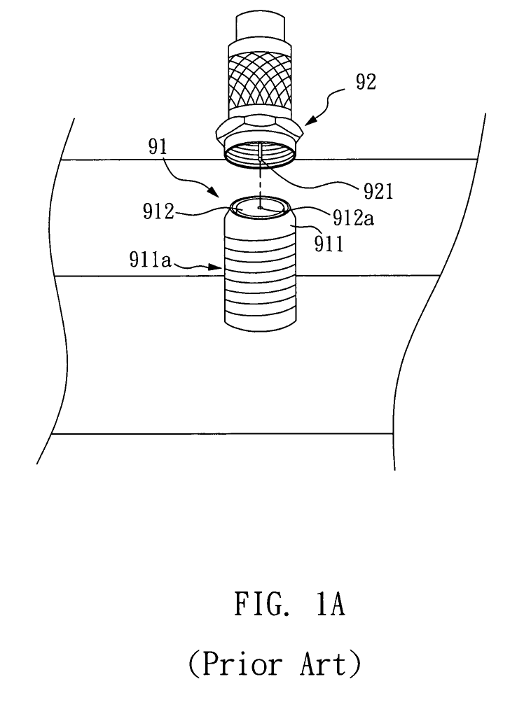

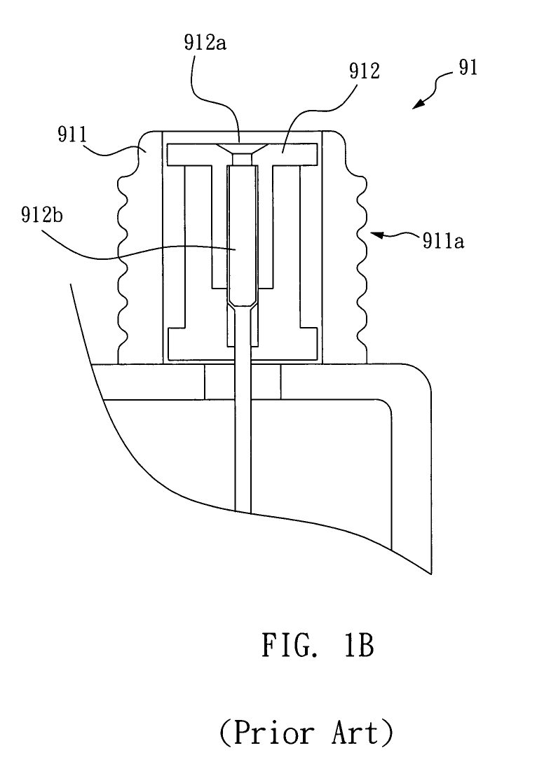

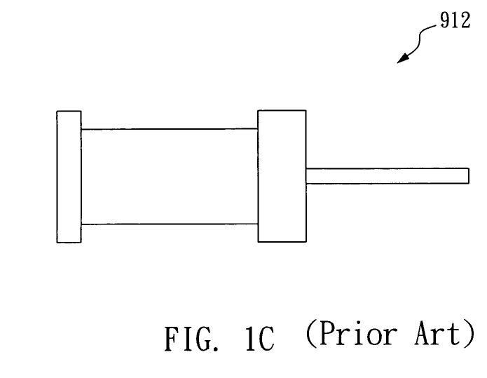

According to one embodiment of the invention, a female adaptor 10 is used in an F-type connector. The female adaptor 10 of the connector is installed on an electronic device (not shown) to connect with the cable having a male adaptor 92 (as shown in FIG. 1A). As shown in FIG. 2 and FIG. 3, the female adaptor 10 comprises an outer ring 20 and an internal component 30. The outer ring 20 has a screw thread 21 which can be screw-fastened with the male adaptor 92 to establish a steady connection between the male adaptor 92 and the female adaptor 10. The internal component 30 comprises a hole 31, a chamber 32, a protruding portion 33, and an electrical transmitting terminal 34. The hole 31 is used for the insertion of the male pin 921 of the male adaptor 92 so that the male pin 921 can be placed into the chamber 32. The electrical transmitting terminal 34 is used to transfer the signals from the cable of the male adaptor 92 to the electronic device.

As compared with the female adaptor 91 of the prior art, the internal component 30 of the female adaptor 10 of the invention further comprises a protruding portion 33. The internal component 30 is able to elongate the length of the chamber 32 by means of the protruding portion 33. As a result, the female adaptor 10 is able to accommodate a lengthy male pin 921 of the male adaptor 92 without pruning the pin. In one embodiment of the invention, the protruding portion 33 is cylindrically shaped to match with the internal shape of the outer ring 20, but the invention is not only limited to this shape. In the invention, the internal component 30 of the protruding portion 33 can fit with the internal shape of the outer ring 20, therefore there is no need to modify the design of the outer ring 20 of the female adaptor 10, and it is also not necessary to prune the male pin 921 of the male adaptor 92. Hence, no additional manufacturing cost is required.

The internal component 30 of the female adaptor 10 of the invention is not only limited to the above mentioned structure.

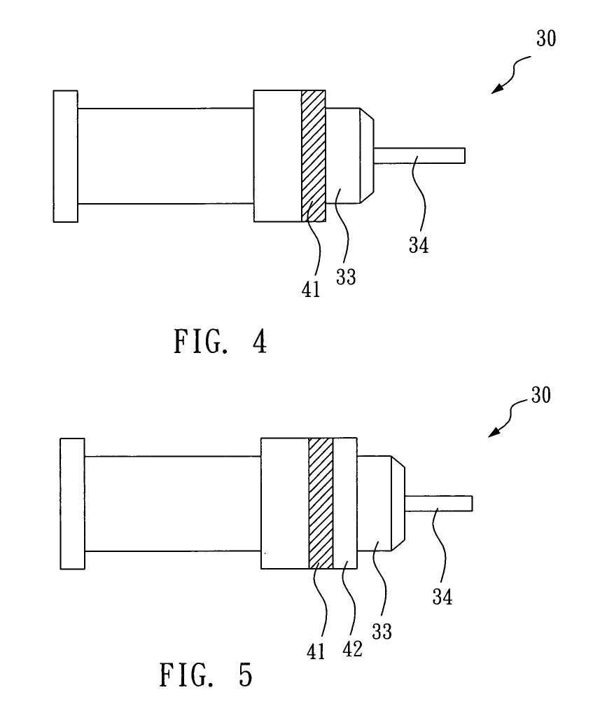

Next, refer to FIG. 4 which shows the internal component of a female adaptor according to an embodiment of the invention consisting of a rubber cushion. As shown in the figure, the internal component 30 can also comprise a rubber cushion 41 to enhance the female adaptor 10's water-proofing effect.

Next, refer to FIG. 5 which shows the internal component of a female adaptor according to an embodiment of the invention having a plastic cushion.

Furthermore, an additional plastic cushion 42 can be included to the internal component 30 of the female adaptor 10 of the invention to spread the pressure endured by the internal component 30 evenly.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A female adaptor for a connector used to match a male adapter having a male pin; the female adapter comprising:
an outer ring having a screw thread used to match with the male adapter; and
an internal component having a hole and a chamber disposed in the outer ring used to accommodate the male pin, wherein the internal component further comprises a protruding portion and is able to match an internal structure of the outer ring and extend the length of the chamber.

2. The female adaptor for a connector as claimed in claim 1, wherein the internal component further comprises a rubber cushion.

3. The female adaptor for a connector as claimed in claim 1, wherein the internal component further comprises a plastic cushion.

4. The female adaptor for a connector as claimed in claim 1, wherein the connector is an F-type connector.

5. The female adaptor for a connector as claimed in claim 1, wherein the protruding portion is cylindrically shaped.
